(19) United States
(12) Patent Application Publication
(10) Pub. No.: US 2004/0066029 A1
(43) Pub. Date: Apr. 8, 2004

(54) Method of making a hardcover book and hardcover apparatus

(76) Inventor: Kevin P. Parker, Berkeley, CA (US)

Correspondence Address: Philip A. Girard, GIRARD & EQUITZ LLP, Suite 1110, 400 Montgomery Street, San Francisco, CA, 94104, US

(21) Appl. No.: 10/262,721

(22) Filed: Oct. 2, 2002

(51) Int. Cl. B42D 3/04

(52) U.S. Cl. 281/4

(57) ABSTRACT

A method of fabricating a book from a bound stack of sheets and a hardcover assembly having first and second relatively rigid cover sections separated by a spine region. A layer of pressure sensitive adhesive is disposed over the inner surfaces of the cover sections, with there being a pair of release liners covering both the pressure sensitive adhesive layers. The book is assembled by placing the hardcover assembly on a surface and removing one of the release liners from one of the pressure sensitive adhesive layers. The bound stack is then positioned on the hardcover assembly, preferably using a guide apparatus to ensure proper positioning, so that the one end sheet of the stack and the and assembly will become attached by the exposed pressure sensitive adhesive. The stack is then folded away from the hardcover assembly in a manner such that the user can access and remove the second release liner thereby exposing the remainder of the adhesive on the one cover section. The stack is then forced down against the one cover section, thereby further securing the one end sheet of the stack to the one cover section. The stack is then rotated to one side so as to expose the two release liners on the other cover section. One release liner is removed, thereby exposing some of the pressure sensitive adhesive, and the other cover section is then rotated over the stack so that the exposed adhesive contacts the other end sheet of the stack. This will cause the second cover section to become attached to part of the other end sheet. The cover section is then lifted so as to permit the second release liner to be removed thereby exposing the remainder of the adhesive. The cover section is then closes thereby securing the cover section to the other end sheet of the stack thereby completing the book.

### BACKGROUND OF THE INVENTION

1. Field of the Invention

The present invention relates generally to the field of bookbinding and, in particular, to a method of fabricating binding a hardcover book using a binder strip and a separate hardcover assembly and to the hardcover assembly itself.

2. Description of Related Art

Binding systems for binding stacks of sheets into a book using desktop equipment have increased in popularity. One popular system uses a binder strip having and adhesive surface, such as disclosed in U.S. Pat. No. 4,496,617. The binder strip is typically applied to a stack of sheets to be bound using a desktop binding machine such as disclosed in U.S. Pat. No. 5,052,873. The binding machine carries out the binding operation by suitably positioning the binder strip relative to the stack to be bound and applying heat and pressure so that the edges of the stack are bound. The bound stack does not, however, have the same general appearance as books using commercial binding processes, particularly that of hardcover books.

Various approaches have been used to produce bound books using desktop equipment that closely resembles hardcover books. One example is disclosed in U.S. Pat. No. 6,155,763 that uses specialized covers having an adhesive layer for binding the stack as opposed to using a conventional binder strip. A company located in Finland and believed to be called Instant Cover Europe Ltd has developed another approach. The stack to be bound is first bound together using the above-described binder strips and binding machine. A hardcover is then applied using high tack adhesives. A positioning apparatus is used to assist in the application of the hardcover to the bound stack to ensure that the cover is accurately positioned over the stack. Unfortunately, the positioning apparatus is relatively complex and includes, for example, a mirror to assist in the assembly. A user having little training is likely to have some difficulty in carrying out the binding process.

There is a need for a binding process using desktop equipment that can be carried out by users having relatively little training and yet produces a hardcover book that compares favorably in appearance with commercially bound books.

### SUMMARY OF THE INVENTION

A method of fabricating a hardcover book is disclosed using a hardcover assembly and a previously bound stack of sheets. The hardcover assembly includes first and second relatively rigid cover sections separated by a relatively flexible spine section, with the first cover section including a first pressure sensitive adhesive layer and first and second release liners disposed over the first pressure sensitive adhesive layer.

The method includes separating the first release liner from the first cover section thereby exposing a first portion of the first pressure sensitive adhesive. The bound stack and the first cover section are positioned so that the bound stack comes in contact with the exposed first portion of the first pressure sensitive adhesive layer. The second release liner is separated from the first cover section thereby exposing a second portion of the first pressure sensitive adhesive layer. The bound stack and the second portion of the first pressure sensitive adhesive are the brought into contact with one another.

### BRIEF DESCRIPTION OF THE DRAWINGS

FIG. 1 is a perspective view of a stack of sheets to be bound, including the front and back folded liner sheets.

FIG. 2 is a perspective view of the stack of sheets of FIG. 1 after binding using a conventional binder strip.

FIG. 3 is a perspective exploded view of the hardcover assembly, with the pressure sensitive front and rear sheets structures shown displaced from the remainder of the assembly.

FIG. 4 is a perspective view of one of the two pressure sensitive adhesive sheet structures.

FIG. 5 is a cross-section elevational view of a portion of the adhesive sheet structure of FIG. 4.

FIG. 6 is a perspective view of the guide apparatus used to attach the hardcover assembly to the bound stack.

FIG. 7 is an expanded side view of a portion of the guide apparatus of FIG. 6 with a stack to be bound shown in position.

FIGS. 8A-8M depict the process for assembling the bound book.

FIGS. 9A and 9B are perspective views of portions of the completed book.

FIG. 10 is a perspective broken view of the completed book shown in an open position.

### DETAILED DESCRIPTION OF THE INVENTION

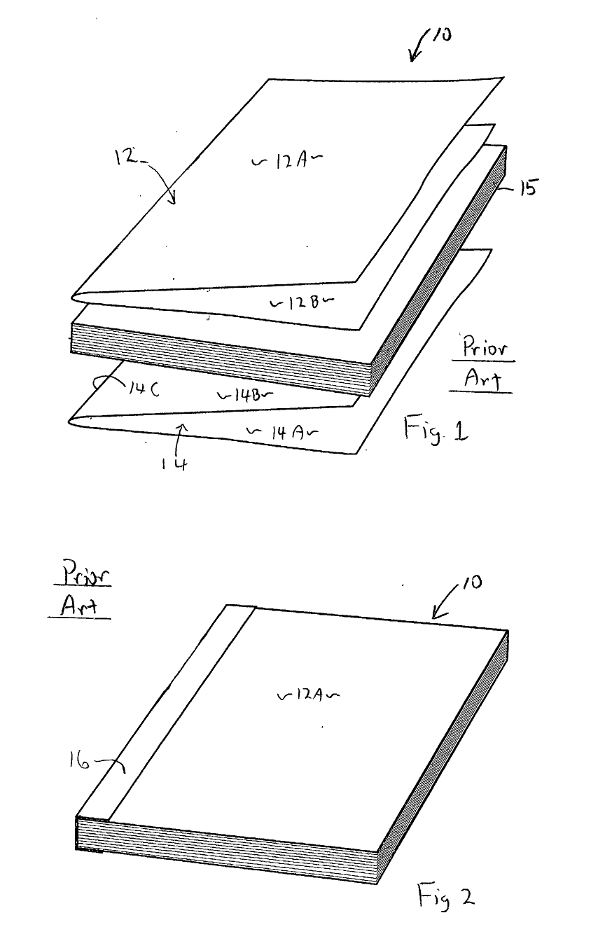

Referring now to the drawings, FIG. 1 shows a stack of sheets 15 to be bound. A first folded liner sheet 12, forming sheets 12A and 12B the same size as the sheets to be bound, is positioned on the top of the stack 15 and a second folded liner sheet 14, forming sheets 14A and 14B, is positioned on the bottom of the stack. The liner sheets 12 and 14 are preferably of a relatively heavy stock as compared to the sheets 15 to be bound. Once the liner sheets 12, 14 and stack of sheets 15 have been assembled, the combined stack 10 is bound together using a conventional binder strip 16 as described in U.S. Pat. No. 4,496,617, the contents of which are hereby fully incorporated by reference into the present application. The actual binding is preferably is carried out using a desktop binding machine as described in U.S. Pat. No. 5,052,873, the contents of which are hereby fully incorporated by reference into the present application. The bound stack 10 is shown in FIG. 2, with the adhesive present in the binder strip 16 operating to bind the individual sheets together and to the paper substrate of the binder strip 16.

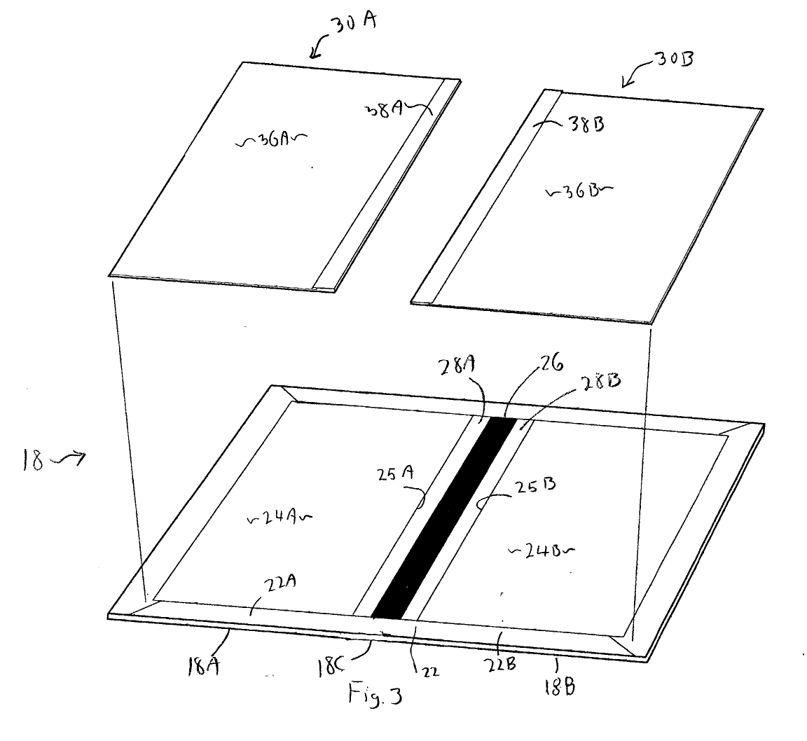

FIG. 3 shows details of the hardcover assembly 18 that is applied to the bound stack 10 of FIG. 2. Preferably, the cover assembly 18 is completely assembled and sold separately to the user. As will be described, the cover assembly 18 will be manufactured in various sizes to accommodate differing size stacks 10 in terms of stack thickness. It is further anticipated that a user can request that certain information be preprinted on the assembly 18, including title information and any other graphics. As will be described, hardcover assembly 18 includes the front and back cover sections halves 18A and 18B, respectively, separated by a spine section 18C.

The cover assembly includes a pair of relatively stiff cover boards 24A and 24B made of cardboard or the like. The cover boards 24A and 24B are typically 8⅜ inches by 11 5/16 inches for binding 8½ by 11 inch stack 10. The cover boards are covered with a flexible cover membrane 22, typically fabric, which is folded around the edges of the cover boards, as depicted in FIG. 3. That part of the cover membrane 22 disposed intermediate the opposite edges 25A and 25B of the cover boards is unsupported and is thus relatively flexible. A length of fabric is preferably disposed in the spine section 18C of the hardcover assembly 18 so as to slightly stiffen the membrane 22 in that location so that a desired shape is achieved when the bound book is opened and closed. The membrane regions 28A and 28B disposed between the respective edges of the spine section 26 and the respective edges 25A and 25B of the cover boards 24A and 24B are referred to as gutter regions. The gutter regions 28A and 28B are each fixed in width at 11/32 of an inch. The gutter regions define the flexible portion of the cover membrane. The spine region 26 varies in width depending upon the width of the stack 10 to be bound. The cover assemblies are preferably prefabricated in various widths to accommodate stacks 10 of various widths as set forth

TABLE 1

| | Spine 26 Width | Stack Thickness |
|---|---|---|
| Model | (inches) | (inches) |
| A | ⅜ | To ¼ |
| B | ⅝ | ¼ to ½ |
| C | ⅞ | ½ to ¾ |
| D | 1⅛ | ¾ to 1 |
| E | 1⅜ | 1 to 1¼ |
| F | 1⅝ | 1¼ to 1½ |

The number of available spine widths can be increased or decreased from the values set forth above in Table 1, with a larger number increasing the difficulty of maintaining an adequate inventory and a smaller number detracting somewhat from the appearance of the final product in the spine region.

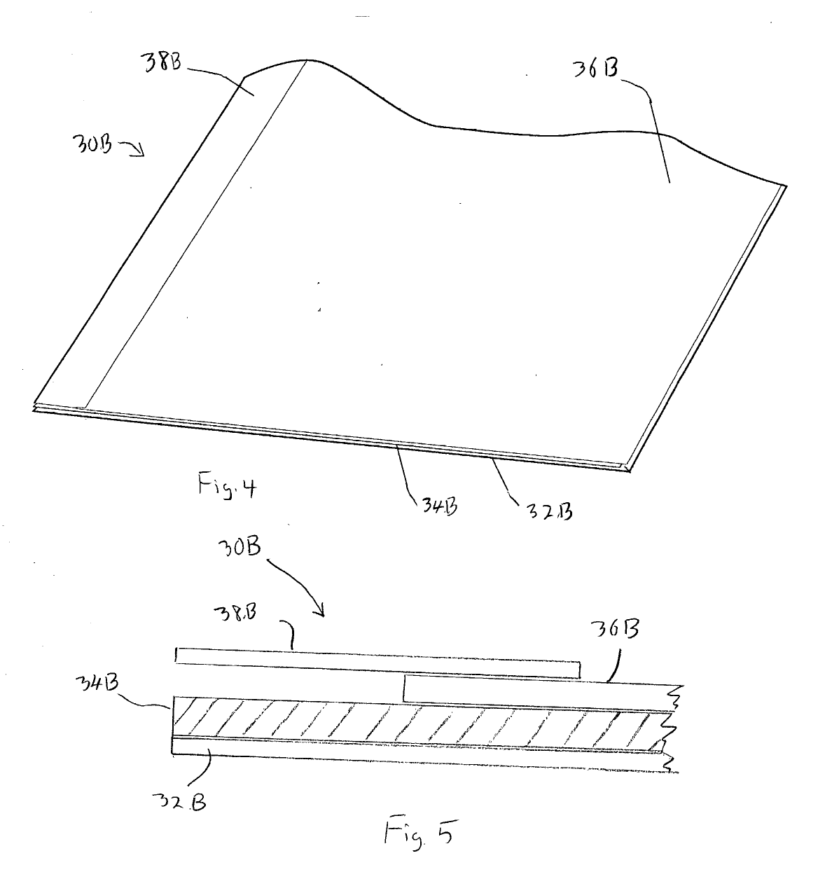

Referring back to FIG. 3, the cover assembly 18 is prefabricated using a pair of pressure sensitive adhesive sheets structure 30A and 30B. Further details of the adhesive sheets are also shown in FIGS. 4 and 5. Adhesive sheet structures 30A and 30B are dimensioned 8¼ by 10¾ inches when the stack 10 size is 8½ by 11 inches, to cover the interior periphery of the folded portions of the cover membrane 22A and 22B and to further secure the periphery of the membrane to the respective cover boards 24A and 24B. The smaller size of the underlying sheets 32A and 32B of the sheet structure ensures that the folded liner sheets 12A and 14A completely cover sheets 32A and 32B despite any small misalignment. Each sheet structure includes a respective bottom sheets 32A and 32B and an upper major release liner 36A and 36B. A layer of pressure sensitive adhesive 34A and 34B is disposed intermediate that upper liner and bottom sheet. A pressure sensitive adhesive manufactured by National Starch and Chemical Company and marketed under the designation Instant-Lok, type HL PSA 20-81, has been found suitable for this application. The adhesive layers 34A and 34B are preferably 0.003 to 0.004 inches in thickness.

The upper major release liners 36A and 36B are disposed over a majority of the underlying pressure sensitive adhesive layers. Generally, at least 75% of the adhesive layers are covered by the respective upper major release liners 36A and 36B, with a remaining strip of the adhesive along the inner edge of the sheet structures not being covered by the major release liners 36A and 36B. Instead, upper minor release liners 38A and 38B are disposed over the exposed adhesive strips. This relationship is shown schematically in FIG. 5 (not to scale) where a portion of the sheet structure 30B is depicted. As can be seen, the pressure sensitive adhesive layer 34B is disposed between the bottom sheet 32B and upper major and minor release liners 36B and 38B. That portion of the adhesive layer 34B not covered by the upper major release liner 36 is covered by a separate upper minor release liner 38B. The minor release liner 38B is actually positioned contacting the adhesive layer 34B and is secured in place by the adhesive layer. As is well know, all of the release liners 36A, 38A, 36B and 38B are fabricated from a material that only slightly adheres to the pressure sensitive adhesive so that the release liners can be manually separated from the adhesive without damage to the adhesive or the release liners. As part of the prefabrication of the hardcover assembly, conventional case glue 56 (not depicted in FIGS. 4 and 5) is applied to the top of the cover sections 18A and 18B and to the bottom sheets 32A and 32B. The sheet structures are then positioned over the respective cover sections 18A and 18B as shown in FIG. 3 so that the sheet structures will be secured to the cover sections by the case glue. Thus, the sheet structures 30A and 30B are secured to the cover boards 24A and 24B and to the peripheral portions of the cover membrane 22 by way of the case glue. This completes the prefabrication of the hardcover assembly 18.

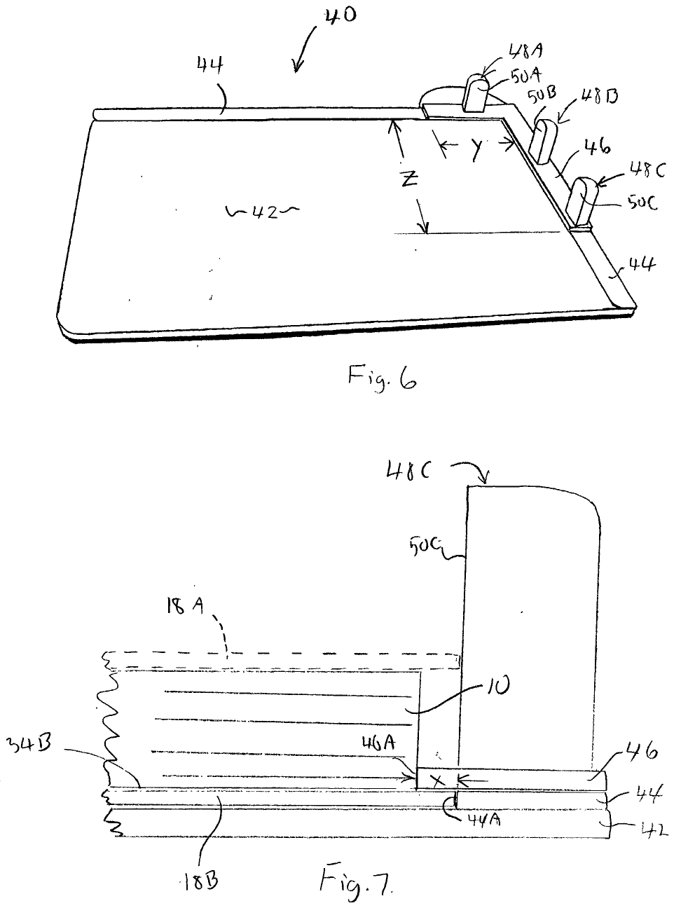

Referring now to FIGS. 6 and 7, a guide apparatus 40 is disclosed for use in carrying out the binding process. The guide apparatus includes a flat base member having a receiving surface 42 that is somewhat larger that the largest book to be bound when the book is in the open position. A stop member 44 having two orthogonal segments is supported on the upper surfaced 42 of the base member and extends around two adjacent sides of the base member. A ledge member 46, also having two orthogonal segments, is supported above the stop member 44 and, as can be in FIG. 7, have outer edges 46A which extend past the edge 44A of the stop member a small distance X, with the overhang being typically 0.16 inches. The height of the ledge member above the support surface is great enough to accommodate the thickness of the cover sections 18A and 18B of the cover assembly 18. The ledge member 46 extends along stop member 44 in one direction a distance Y (FIG. 6) which is somewhat smaller than the closed width of the smallest book to be bound. The distance Z, the distance that the ledge member 46 extends along stop member 44 in the other direction, is typically about twice dimension Y.

The guide apparatus 40 also preferably includes two or more vertical stop members, such as 48A, 48B and 48C, with vertical stop member 48A being supported on ledge member 46 about one third of the distance Y of the ledge member from the corner formed by the intersection of the two ledge member 46 segments. Vertical stop member 48B and 48C are at approximate equal distances along the other ledge member 46 segment. As can best be seen in FIG. 7, the vertical stop members each have a planar surface, surface 50C for example, that coincides with the inner edge, edge 44A for example, of the stop member. This configuration also applies to the planar surfaces 50A and 50B of vertical stop members 48A and 48B.

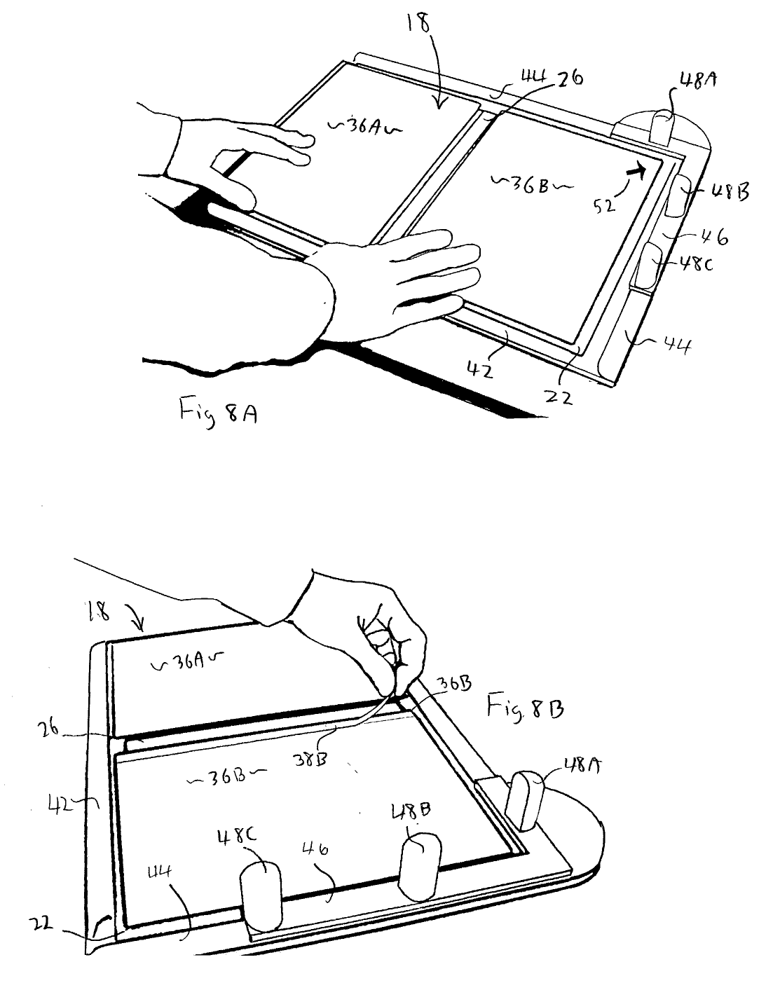

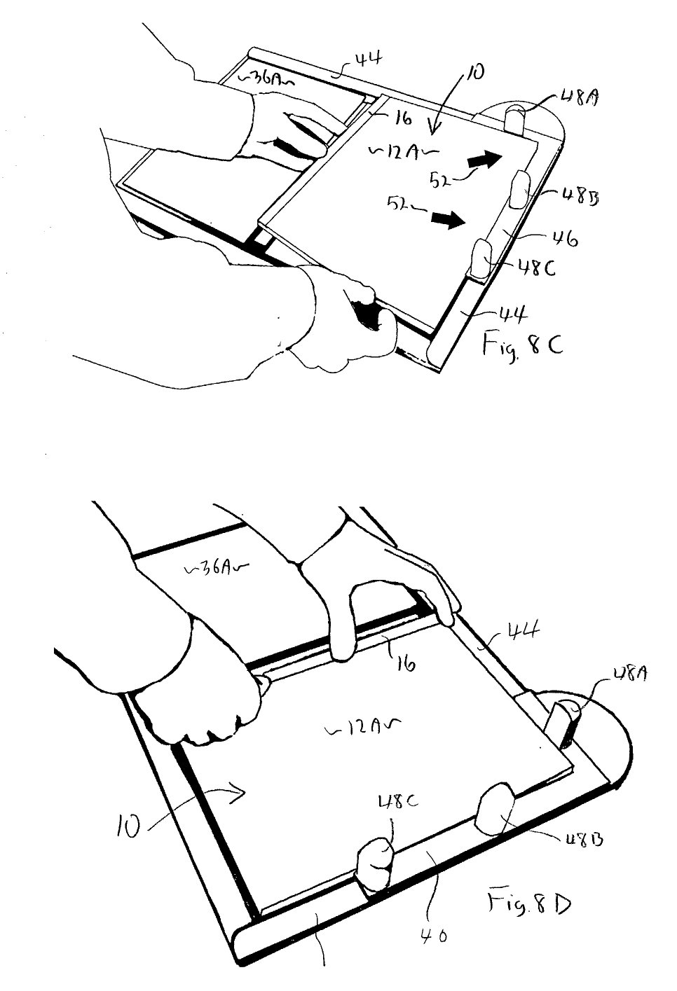

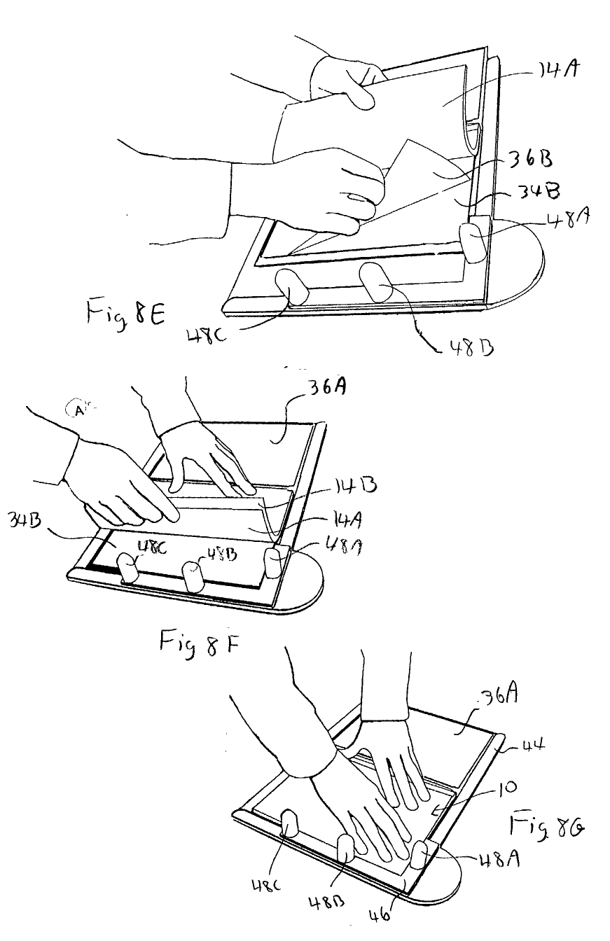

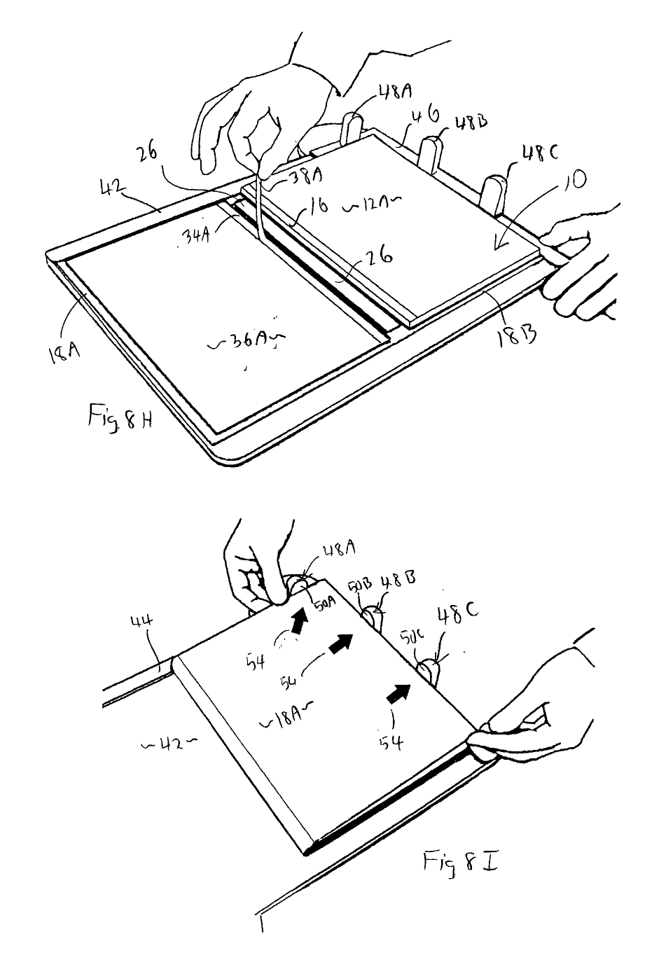

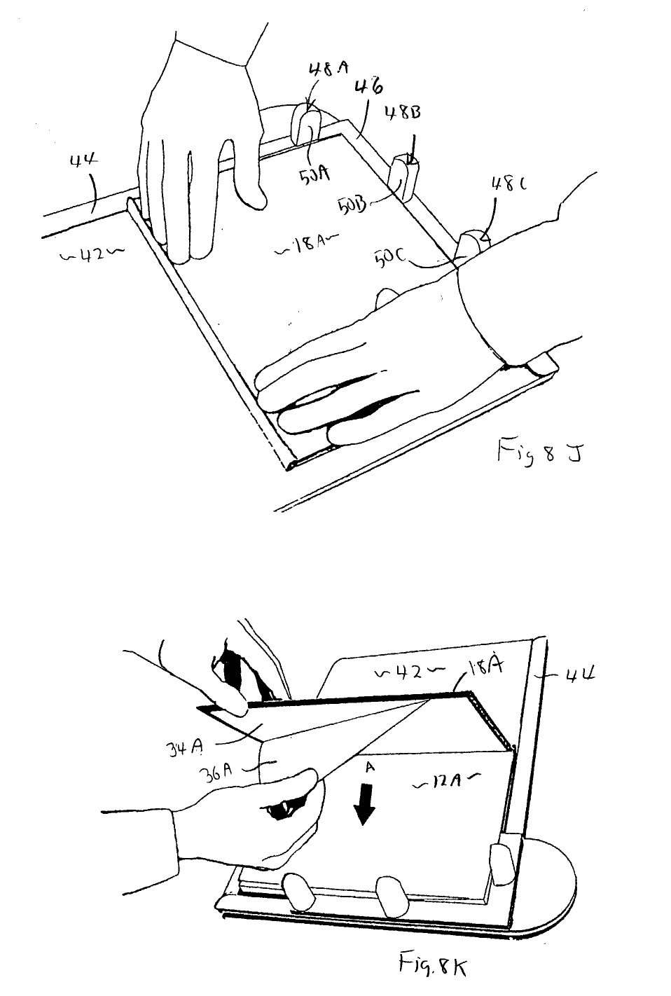

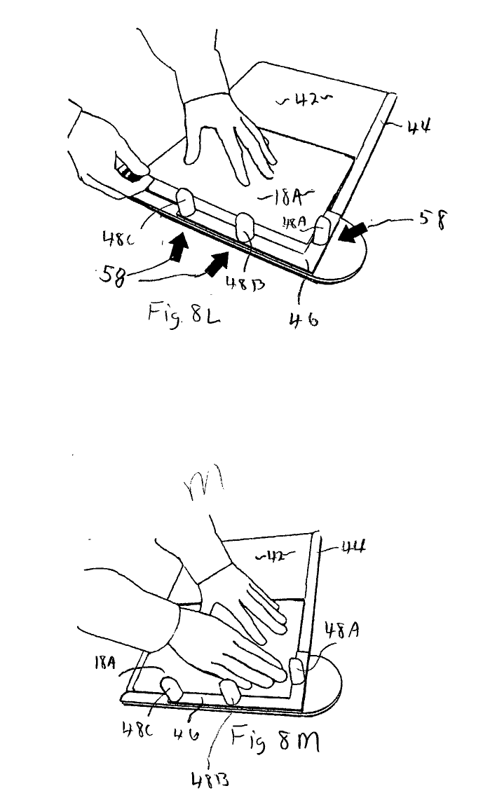

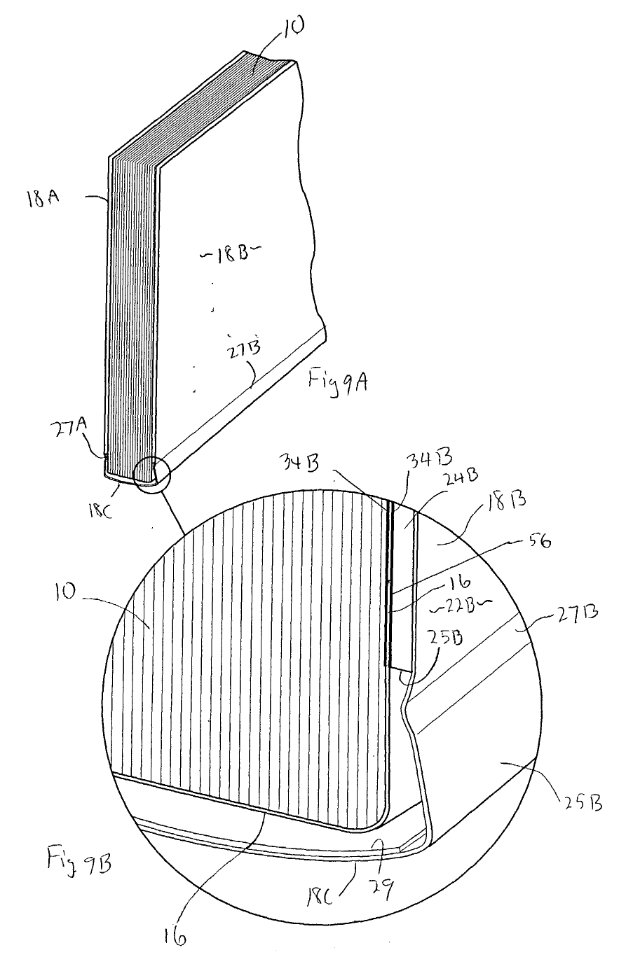

The book binding sequence will now be described, starting with reference to FIG. 8A. The opened hardcover assembly 18 is first positioned on the guide apparatus receiving surface 42, with the upper release liners 36A and 36B facing upwards. As indicated by arrow 52, the hardcover assembly is moved along the surface 42 of the guide apparatus until the edges of cover section 18B is positioned under the ledge member 46, abutting the inner edge 44A of the stop member 44A, as shown in FIG. 7. Thus, the outer edge 46A of the ledge member 46 will be positioned a fixed distance X from the edge of cover 18B along the full length of both orthogonal segments of the ledge member 46. The outer edge 46A will provide a guide for positioning the bound stack 10, as will be described.

Once the hardcover assembly 18 is properly positioned on the guide apparatus 40, the user manually separates the upper minor release liner 38B as shown in FIG. 8B from the assembly 18. This will expose a relatively narrow strip of the underlying pressure sensitive adhesive 34B adjacent spine region 26. Next, the bound stack 10 is placed over the upper major release liner 36B, with the edges of the stack engaging edge 46A of the ledge member 46 along both orthogonal segments. FIG. 7 shows the edge of stack 10 engaging edge 46A along one of the two segments. As shown in FIG. 8C by arrows 52, that portion of stack 10 along the exposed adhesive 34B is not placed on the exposed adhesive until the orthogonal edges of the stack are positioned against edge 46A of both segments. Once the correct position is achieved, the stack is forced down upon the exposed pressure sensitive adhesive 34B as shown in FIG. 8D. This operates to secure the folded liner sheet 14A of stack 10 to cover section 18B of the hardcover assembly 18 in a correctly aligned position.

The next step is to secure the remainder of the folded liner sheet 14A of stack 10 to the adhesive 34B of assembly 18. Referring to FIG. 8E, the free edge of stack 10, including liner sheet 14A, is lifted up and rotated away from the upper major release liner 36B. This permits the release liner 36B to be separated from the hardcover assembly 18 thereby exposing the remainder of the pressure sensitive adhesive 34B. As shown in FIG. 8F, the spine portion of stack 10 held down against the hardcover assembly 18 with one hand while stack 10 is rotated over the adhesive 34B with the other hand. As shown in FIG. 8G, the user then presses the stack 10 down on the hardcover assembly 18. This causes the remainder of the liner sheet 14A of the stack to be secured by the remainder of adhesive 34B to cover section 18B of the hardcover assembly 18. The second cover section 18A of the hardcover assembly will now be attached.

Referring to FIG. 8H, the upper minor release liner 38A is next separated from the hardcover assembly 18 thereby exposing a strip of pressure sensitive adhesive 34A adjacent spine region 26. The user then lifts the cover section 18A of the hardcover assembly away from the surface 42 of the guide apparatus and rotates the cover 18A around the spine. As indicated by arrows 54 of FIG. 81, the cover section 18A is positioned so that the edges of the cover section 18A contact the planar surfaces 50A, 50B and 50C of the respective three vertical stop members 48A, 48B and 48C. This is shown in phantom in FIG. 7. The hardcover assembly 18 is then positioned correctly with respect to the bound stack 10. The user then forces the cover section 18A down as shown in FIG. 8J so that an edge of folded liner sheet 12A of stack 10 is secured to the hardcover assembly 18 by way of the exposed strip of adhesive 34A.

As shown in FIG. 8K, the user then lifts cover section 18A up and rotates the cover away from stack 10, with a narrow strip of liner sheet 12A of the stack remaining secured to cover section 18A. This permits upper major release liner 36A to be separated from hardcover assembly 18 thereby exposing the remainder of pressure sensitive adhesive layer 34A. Cover 18A is then placed rotated back down onto stack 10, where the edges of the cover should again be in contact with the surfaces 50A, 50B and 50C of the respective stops 48A, 48 and 48C as shown in FIG. 8L by arrows 58. The user then presses down on cover section 18A as shown in FIG. 8M thereby securing the cover section 18A to folded liner sheet 12A of stack 10. This completes the binding sequence.

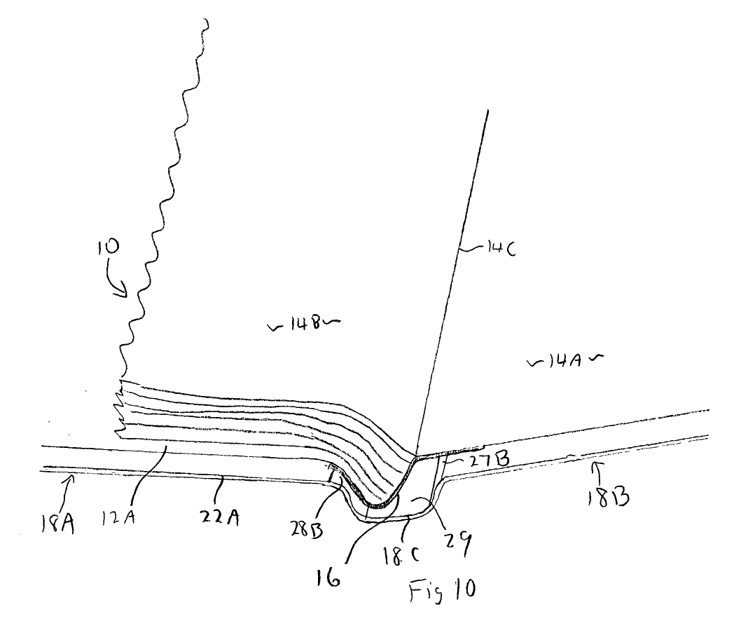

FIGS. 9A and 9B show the completed book in a closed position and FIG. 10 shows the book in an opened position, at the last page of the book, so that folded liner sheets 14A and 14B are depicted. Sheet 14A is secured to hardcover section 18B by way of adhesive 34B and sheet 12A at the front of the book (not depicted) is secured to hardcover section 18A by adhesive 34A. The region between the binder strip 16 and the spine region 18C is not attached so that, when the book is opened as shown in FIG. 10, the spine region does not attempt to fold with the binder strip 16. Thus, the book will lay flat when opened and will not tend to fold shut. Further, the spine region 18C will not distort when the book is opened to the same degree it would if the spine region 18C was attached. As previously noted, a fairly stiff fabric strip 29 is positioned in the spine region intermediate the gutter regions 28A and 28B (FIG. 3) so as to hold the shape of the spine region 29 when the book is opened and closed. Fold lines 27A and 27B are formed naturally in the membrane 22 in the regions near the edges 25A and 25B of the cover boards thereby further enhancing the appearance of the final product.

Thus, a novel method of binding a hardcover book has been disclosed. Although one embodiment of the present invention has been described in some detail, it is to be understood that certain changes could be made by those skilled in the art without departing from the scope of the invention as defined by the appended claims. By way of example, it would be possible to have major and minor release liners, such as liners 36A and 36B, formed from one sheet but separated by perforations. A user would then separate the minor release liner from the major release liner by simply tearing the sheet along the perforations.

What is claimed is:

1. A method of fabricating a hardcover book comprising:
providing a bound stack of sheets;
providing a hardcover assembly including first and second relatively rigid cover sections separated by a relatively flexible spine section, with the first cover section including a first pressure sensitive adhesive layer and first and second release liners disposed over the first pressure sensitive adhesive layer;
separating the first release liner from the first cover section thereby exposing a first portion of the first pressure sensitive adhesive;
positioning the bound stack and the first cover section so that the bound stack comes in contact with the exposed first portion of the first pressure sensitive adhesive layer;
separating the second release liner from the first cover section thereby exposing a second portion of the first pressure sensitive adhesive layer; and
bringing the bound stack and the second portion of the first pressure sensitive adhesive into contact with one another.

2. The method of claim 2 wherein the second cover section of the hardcover assembly further includes a second pressure sensitive adhesive layer and third and fourth release liners disposed over the second pressure sensitive adhesive layer and wherein the method further includes:
separating the third release liner from the second cover section thereby exposing a first portion of the second pressure sensitive adhesive;
positioning the bound stack and the second cover section so that the bound stack comes in contact with the exposed first portion of the second pressure sensitive adhesive layer;
separating the fourth release liner from the second cover section thereby exposing a second portion of the second pressure sensitive adhesive; and
bringing the bound stack and the second portion of the second pressure sensitive adhesive into contact with one another.

3. The method of claim 2 wherein the first portion of the first pressure sensitive adhesive forms a first adhesive strip which is disposed on the first cover section along the spine section of the hardcover assembly and the first portion of the second pressure sensitive adhesive forms a second adhesive strip which is disposed on the second cover section along the spine section of the hardcover assembly, with the second portions of the first and second pressure sensitive adhesive layers forming at least 75% of the respective first and second pressure sensitive adhesive layers.

4. The method of claim 3 further including providing a guide apparatus which includes a receiving surface, a stop member having respective first and second stop surfaces, with the first stop surface being positioned to engage a first edge of the first cover section when the hardcover assembly is placed on the receiving surface and wherein the second stop surface is being positioned to engage a first edge of the bound stack when the first cover section is positioned on the receiving surface and the bound stack is positioned on the first cover section, with the first and second stop surfaces being at differing positions along a line parallel to the receiving surface and wherein the positioning the first cover section and the bound stack includes positioning the first cover section and the bound stack on the guide apparatus so that the first edge of the first cover section engages the first stop surface and the first edge of the bound stack engages the second stop surface.

5. The method of claim 4 wherein the stop member of the guide apparatus further includes a third stop surface aligned at the same position along the line parallel to the receiving surface as the first stop surface and wherein the positioning the bound stack and the second cover section includes positioning the hardcover assembly and the bound stack on the guide apparatus so that the first edge of the first cover section and a first edge of the second cover section engage the respective first and third stop surfaces.

6. The method of claim 5 wherein the stop member further includes fourth, fifth and sixth stop surfaces displaced from the first, second and third stop surfaces, with the fourth, fifth and sixth stop surfaces having a position relative to one another corresponding to the respective first, second and third stop surfaces and wherein the positioning the bound stack and the first cover section includes the positioning the first cover section and the bound stack on the guide apparatus so that the first edge of the first cover section and a second edge of the first cover section, orthogonal to the first edge of the first cover section, engage the first and fourth stop surfaces, respectively, and so that first edge of the bound stack and a second edge of the bound stack, orthogonal to the first edge of the bound stack, engage the second and fifth stop surfaces respectively.

7. The method of claim 6 wherein the positioning the bound stack and the second cover section includes positioning the hardcover assembly and the bound stack on the guide apparatus so the first edge of the first cover section and a second edge of the first cover section, orthogonal with respect to the first edge of the first cover section, engage the first and fourth stop surfaces, respectively, and so that the first edge of the second cover section and a second edge of the second cover section, orthogonal to the first edge of the second cover section, engage the third and sixth stop surfaces, respectively.

8. A hardcover assembly for fabricating a hardcover book comprising:
first and second relatively rigid cover sections separated by a relatively flexible spine section;
a first layer of pressure sensitive adhesive disposed over a first surface of the first cover section;
a first release liner disposed over a first portion of the first layer of pressure sensitive adhesive; and
a second release liner disposed over a second portion of the first layer of pressure sensitive adhesive.

9. The hardcover assembly of claim 8 further including:
a second layer of pressure sensitive adhesive disposed over a first surface of the second cover section;
a third release liner disposed over a first portion of the second layer of pressure sensitive adhesive; and
a fourth release liner disposed over a second portion of the second layer of pressure sensitive adhesive.

10. The hardcover assembly of claim 9 wherein the second portions of the first and second layers of pressure sensitive adhesive comprise at least 75% of the respective first and second layers of pressure sensitive adhesive.

11. The hardcover assembly of claim 10 further including a flexible membrane which extends over second surfaces of the first and second cover sections, opposite the first surface and which forms at least part of the spine region.
